(19) United States
(12) Patent Application Publication
(10) Pub. No.: US 2015/0167560 A1
(43) Pub. Date: Jun. 18, 2015

(54) VARIABLE VALVE LIFT DIAGNOSTIC TECHNIQUES USING AN INTAKE MANIFOLD ABSOLUTE PRESSURE SIGNAL

(71) Applicants: Zhijian James Wu, Rochester Hills, MI (US); Brian P. Gebby, Macomb, MI (US)

(72) Inventors: Zhijian James Wu, Rochester Hills, MI (US); Brian P. Gebby, Macomb, MI (US)

(21) Appl. No.: 14/132,913

(22) Filed: Dec. 18, 2013

(51) Int. Cl. F02D 13/02

(52) U.S. Cl. CPC F02D 13/0253

(57) ABSTRACT

A method can include receiving, at a controller for an internal combustion engine, the controller having one or more processors, an intake manifold absolute pressure (MAP) signal indicative of an air pressure in an intake manifold of the engine. The method can include processing, at the controller, the MAP signal in a crank angle domain to obtain distinct portions of the MAP signal corresponding to cylinders of the engine, respectively. The method can include calculating, at the controller, a valve stuck index value based on the distinct portions of the MAP signal. The method can also include detecting, at the controller, one or more stuck valves of the engine based on the valve stuck index value and one or more thresholds.

### FIELD

The present disclosure relates generally to vehicle diagnostic systems and, more particularly, to variable valve lift (VVL) diagnostic techniques using an intake manifold absolute pressure (MAP) signal.

### BACKGROUND

An internal combustion engine can draw air into an intake manifold through an induction system that can be regulated by a throttle. The air in the intake manifold can be distributed to a plurality of cylinders via respective intake valves and combined with fuel to create an air/fuel mixture. The air/fuel mixture can be compressed and combusted to rotatably turn a crankshaft and generate drive torque. Exhaust gas can be expelled from the cylinders via respective exhaust valves.

A variable valve lift (VVL) system can adjust lift of the intake and/or exhaust valves based on operating parameters of the engine. For example, the VVL system may increase maximum valve lift at high engine loads and the VVL system may decrease maximum valve lift at low engine loads. In some cases, a valve can become stuck at a particular lift, which can cause increased emissions and/or decreased fuel economy if not corrected.

### SUMMARY

In one form, a method is provided in accordance with the teachings of the present disclosure. The method receiving, at a controller for an internal combustion engine, the controller having one or more processors, an intake manifold absolute pressure (MAP) signal indicative of an air pressure in an intake manifold of the engine. The method can include processing, at the controller, the MAP signal in a crank angle domain to obtain distinct portions of the MAP signal corresponding to cylinders of the engine, respectively. The method can include calculating, at the controller, a valve stuck index value based on the distinct portions of the MAP signal. The method can also include detecting, at the controller, one or more stuck valves of the engine based on the valve stuck index value and one or more thresholds.

In another form, an engine system is provided in accordance with the teachings of the present disclosure. The engine system can include an internal combustion engine and a controller. The engine can be configured to combust an air/fuel mixture to generate drive torque. The controller can be configured to receive a MAP signal indicative of an air pressure in an intake manifold of the engine. The controller can be configured to process the MAP signal in a crank angle domain to obtain distinct portions of the MAP signal corresponding to cylinders of the engine, respectively. The controller can be configured to calculate a valve stuck index value based on the distinct portions of the MAP signal. The controller can also be configured to detect one or more stuck valves of the engine based on the valve stuck index value and one or more thresholds.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is an example diagram of an engine system according to the principles of the present disclosure;

FIG. 2 is an example functional block diagram of a controller of the engine system according to the principles of the present disclosure;

FIG. 3 is an example functional block diagram of a software architecture according to the principles of the present disclosure;

FIG. 4 is an example graph of an intake manifold absolute pressure (MAP) signal according to the principles of the present disclosure;

FIG. 5 is an example graph of various valve stuck index (VSI) signals according to the principles of the present disclosure; and

FIG. 6 is an example flow diagram of a variable valve lift (VVL) diagnostic method using a MAP signal according to the principles of the present disclosure.

### DESCRIPTION

Air pressure in an intake manifold of an internal combustion engine can be measured using an intake manifold absolute pressure (MAP) sensor. The MAP and operation of intake and exhaust valves of the engine can collectively affect air charges or an air-per-cylinder (APC) for the engine. A variable valve lift (VVL) system can control a maximum lift of the intake and exhaust valves, which can also affect how much air is flowing in and out of the cylinders. When one or more of the valves is stuck at a particular lift, fuel economy and/or emissions can be negatively affected. Because the MAP is based on VVL operation, the MAP signal may indicate whether any valves are stuck.

Accordingly, VVL diagnostic techniques using a MAP signal are presented. The techniques can provide for more accurate VVL diagnostics by distinguishing between a single stuck valve for a single cylinder, a single stuck valve for two or more cylinders, and two stuck valves for each of one or more cylinders. Engines typically include MAP sensors, and thus these VVL diagnostic techniques can also be achieved without implementing additional sensor(s), which can decrease costs. The MAP signal is also very robust across all engine loads. Further, by more accurately diagnosing stuck valves and also distinguishing between different stuck valve scenarios, potential warranty costs can be decreased.

The techniques can include processing the MAP signal into distinct portions that correspond to cylinders of an engine, respectively. The techniques can determine a valve stuck index value based on the distinct portions of the MAP signal. The techniques can then detect a stuck valve(s) based on the valve stuck index value and one or more thresholds. In one implementation, different thresholds can be used for a single stuck valve for a single cylinder, a single stuck valve for two or more cylinders, and two stuck valves for each of one or more cylinders. The techniques can also increment a counter when stuck valve(s) are detected. When the counter exceeds a predetermined threshold, the techniques can generate and output a fault, e.g., a malfunction indicator lamp (MIL), and/or adjust operation of the engine, e.g., command a limp-home mode.

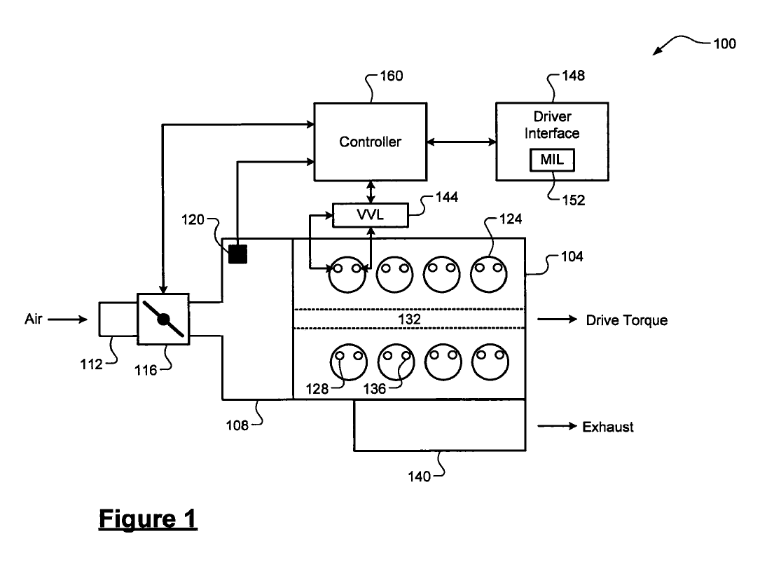

Referring now to FIG. 1, an example diagram of an engine system 100 is illustrated. The engine system 104 can include an internal combustion engine 104 (hereinafter “engine 104”) configured to combust an air/fuel mixture to generate drive torque. Examples of the engine 104 include a spark ignition (SI) engine, a diesel engine, and a homogeneous charge compression ignition (HCCI) engine. While the engine 104 is shown to be a naturally-aspirated engine, it should be appreciated that the engine 104 could be configured for forced-induction (a supercharger, a turbocharger, etc.) and the techniques of the present disclosure could be adjusted to account for the different MAP levels.

The engine 104 can draw air into an intake manifold 108 through an induction system 112 that can be regulated by a throttle 116. For example, the throttle 116 may be actuated using electronic throttle control (ETC). A MAP sensor 120 can measure a pressure of the air in the intake manifold (MAP) and generate a MAP signal indicative of the MAP. In one implementation, the MAP signal can be a discrete signal sampled in a crank angle domain. The air in the intake manifold 108 can be distributed to a plurality of cylinders 124 (hereinafter “cylinders 124”) via respective intake valves 128 and combined with fuel to create an air/fuel mixture.

The air/fuel mixture can be compressed and combusted within the cylinders 124, e.g., using pistons (not shown), to rotatably turn a crankshaft 132 and generate drive torque. Exhaust gas resulting from combustion can be expelled from the cylinders 124 via respective exhaust valves 136 and into an exhaust system 140. The exhaust system 140 can treat the exhaust gas before releasing it into the atmosphere. The exhaust system 140 can include an exhaust manifold and any suitable exhaust treatment components, e.g., a catalytic converter.

A VVL system 144 can control lift of the intake valves 128 and/or the exhaust valves 132. More particularly, the VVL system 144 can adjust a maximum lift of the intake valves 128 and/or the exhaust valves 136. For example, the VVL system 144 may increase the maximum valve lift as high engine loads and decrease the maximum valve lift at low engine loads. In one implementation, the VVL system 144 can be a two-step valve system including a switchable roller finger follower and an oil control valve for each valve of each of the cylinders 124.

The engine system 100 can also include a driver interface 148, including an MIL 152, and a controller 160. The controller 160 can control operation of the engine 104. In particular, the controller 160 can control operation of the engine 104 in response to a torque request via the driver interface 148, e.g., an accelerator pedal, such that the engine 104 generates a desired drive torque. The MIL 152 can be actuated to notify a driver that the engine 104 needs service. In the context of the present disclosure, the MIL 152 can be associated with the VVL system 144 and can be utilized to notify the driver that the VVL system 144 needs service, e.g., one or more of the intake valves 128 and the exhaust valves 136 are stuck at a particular valve lift.

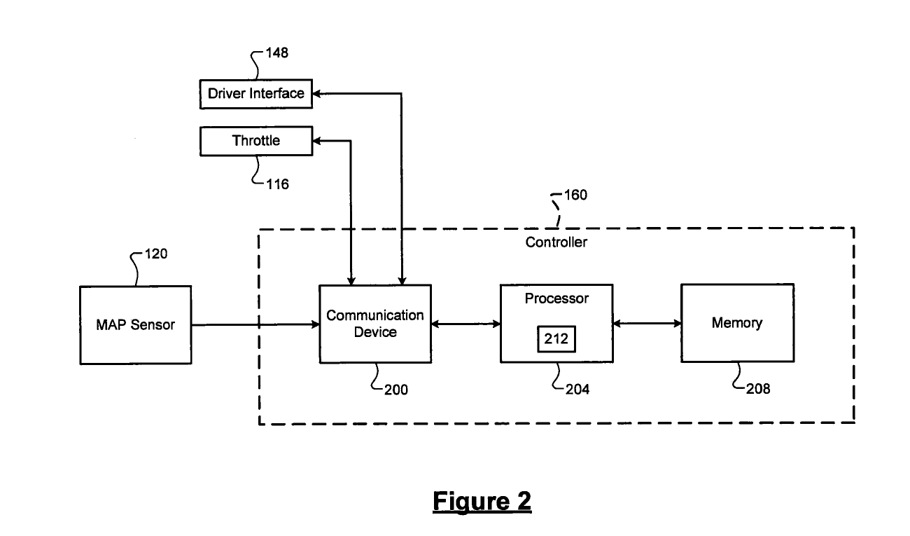

Referring now to FIG. 2, an example functional block diagram of the controller 160 is illustrated. The controller 160 can include a communication device 200, a processor 204, and a memory 208. It should be appreciated that the term “processor” as used herein can refer to both a single processor and two or more processors operating in a parallel or distributed architecture. The memory 208 can be any suitable storage medium (flash, hard disk, etc.) configured to store information at the controller 160. For example, the memory 208 may store the valve stuck index (VSI) thresholds and/or the predetermined threshold for the counter, which are described in greater detail below.

The communication device 200 can include any suitable components, e.g., a transceiver, configured for communication with components of the engine system 100 via a controller area network (CAN) (the throttle 116, the MAP sensor 120, the VVL system 144, the driver interface 148, the MIL 152, etc.). It should be appreciated that the communication device 200 can also be configured to communicate with other components (a remote server, a mobile phone, another vehicle, etc.) via another network, such as a local area network (LAN), e.g., Bluetooth communication, or a wide area network (WAN), e.g., the Internet.

The processor 204 can be configured to control operation of the controller 160. These functions can include, but are not limited to, loading/executing an operating system of the controller 160, controlling information sent via the communication device 200, processing information received via the communication device 200, and controlling read/write operations at the memory 208. The processor 204 can also wholly or partially execute the VVL diagnostic techniques of the present disclosure. More particularly, the processor 204 can be configured to execute a set of instructions based on software architecture 212, the details of which are now described in greater detail below.

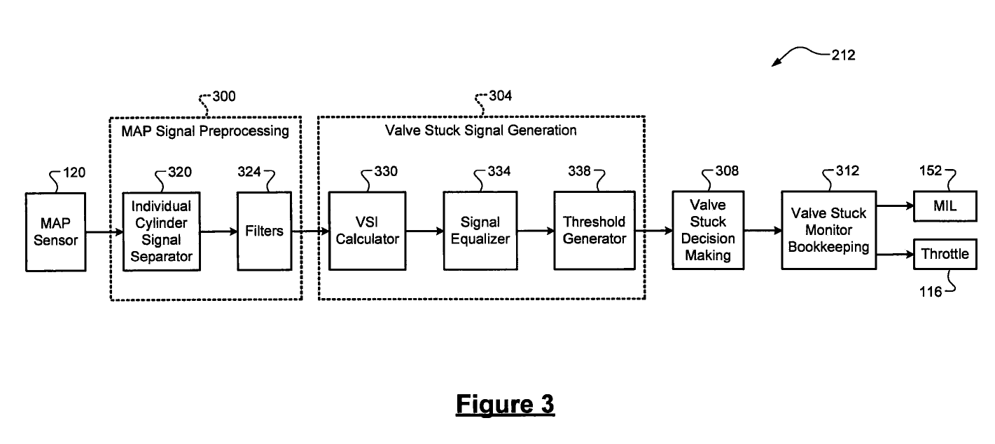

Referring now to FIG. 3, an example functional block diagram of the software architecture 212 is illustrated. As mentioned above, the software architecture 212 can represent a set of instructions for executing by the processor 204. The software architecture 212 can be generally divided into MAP signal preprocessing 300, valve stuck signal generation 304, valve stuck decision making 308, and valve stuck monitor bookkeeping 312. The MAP signal preprocessing can further include an individual cylinder signal separator 320 and filters 324. The valve stuck signal generation 304 can further include VSI calculator 330, a signal equalizer 334, and a threshold generator 338.

The individual cylinder signal separator 320 can divide the MAP signal from the MAP sensor 120 into distinct portions corresponding to the cylinders 124, respectively. These distinct portions can correspond to a firing order of the cylinders 124. The firing order of the cylinders 124 represents a sequence in which the cylinders 124 ignite their air/fuel mixture to cause combustion. For example only, the engine 104 may include six cylinders 1-6, and the firing order may be 1, 2, 4, 3, 5, 6.

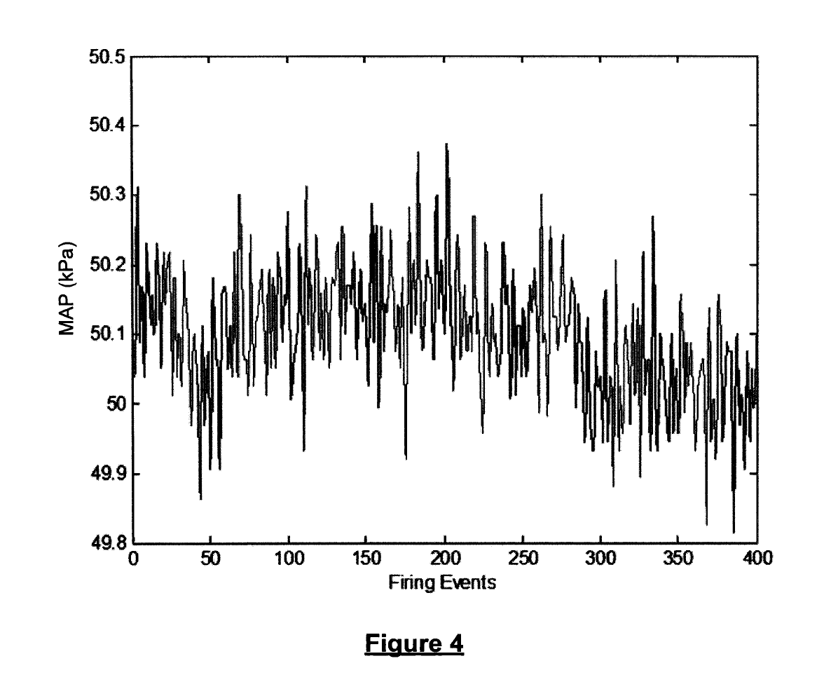

FIG. 4 illustrates an example graph of a MAP signal. As previously mentioned, the MAP signal can be processed in the crank angle domain. Each firing event can represent a number of crank angle degrees (CAD) between firing of the cylinders 124. For example only, the engine 104 may include six cylinders and each firing event can represent 120 CAD. By processing the MAP signal in the crank angle domain, the MAP signal can be more easily divided into its distinct portions for the cylinders 124 compared to processing the MAP signal in a time domain.

As shown in FIG. 4, the MAP signal can be noisy and can have a low signal-to-noise ratio (SNR). The filters 324 can be used to filter the MAP signal and/or its distinct portions for improved processing. For example, the filters 324 can include a low-pass filter (LPF) for smoothing each distinct portion of the MAP signal.

The filters 324 can also include other suitable filters for removing MAP signal noise and increasing SNR. It should be appreciated, however, that a band-pass filter could be used prior to the individual cylinder signal separator 320 for removing MAP signal noise and increasing SNR. For example only, the MAP signal shown in FIG. 4 can be band-pass filtered first before its further processing.

Referring still to FIG. 3, the VSI calculator 330 can calculate a valve stuck index (VSI), and can be obtained by calculating a norm of the distinct portions of the MAP signal. The smoothed distinct portions of the MAP signal corresponding to each cylinder can be represented as a vector:

S=[s₁, s₂, . . . , sₙ].

Thus, the VSI can be represented as follows:

VSI=∥S∥,

where ∥S∥ mathematically represents the norm of the signal S=[s₁, s₂, . . . sₙ].

In one implementation, the VSI calculator 330 can calculate the VSI as follows:

VSI=\sqrt{s₁²+s₂² . . . +sₙ²}.

It should be appreciated that other norm or VSI definitions can be used by the VSI calculator 330 to calculate the VSI. For example, the VSI calculator 330 may calculate the square of VSI above.

The signal equalizer 334 can equalize the VSI based on engine speed and/or engine load. In other words, the VSI can be adjusted based on engine speed and/or engine load. The threshold generator 338 can generate one or more thresholds for detecting stuck valve(s). Each threshold can correspond to a different stuck valve scenario. As previously discussed, these thresholds can include (i) a single stuck valve for a single cylinder, (ii) a single stuck valve for two or more cylinders, and (iii) two stuck valves for each of one or more cylinders. These thresholds can be generated using predetermined dynamometer data for the engine 104, e.g., stored at the memory 208. The thresholds can be (i) predetermined, (ii) generated as real-time dynamic thresholds, or (iii) generated using a look-up table.

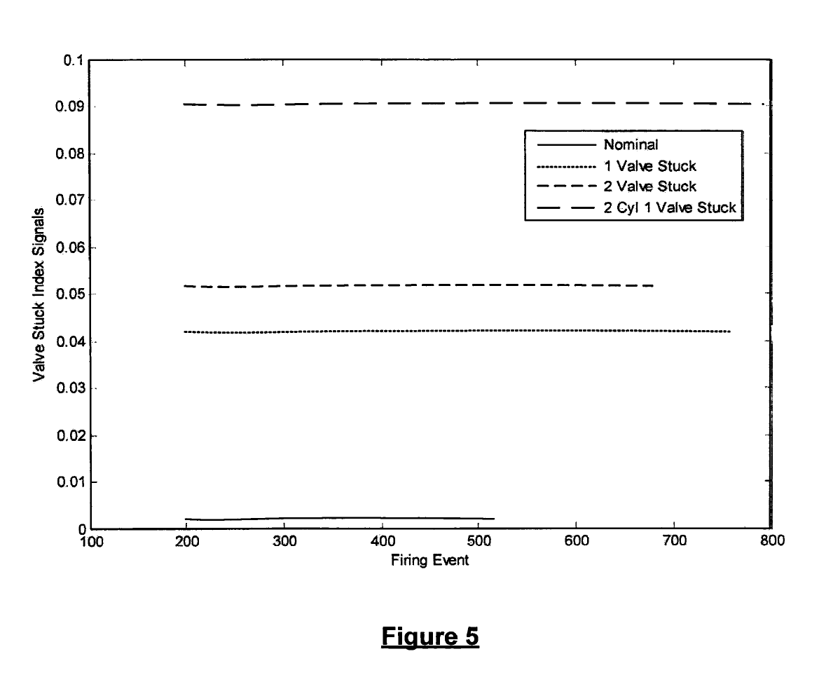

FIG. 5 illustrates an example graph of predetermined dynamometer data for the three different scenarios discussed above. As shown, each of these scenarios corresponds to a different VSI value that is different than the nominal (no stuck valve) VSI value. The threshold generator 338 can generate the threshold(s) such that the calculated VSI value can be matched to a particular scenario. In other words, the threshold generator 338 could generate thresholds or threshold ranges to distinguish between the different scenarios. For example, a first threshold may be 0.01-0.045 (a single stuck valve for a single cylinder), a second threshold may be 0.045-0.07 (two stuck valves for each of one or more cylinders, and a third threshold may be greater than 0.07 (a single stuck valve for two or more cylinders).

The valve stuck decision making 308 can detect stuck valve(s) based on the calculated VSI and the one or more thresholds. To prevent incorrectly diagnosing stuck valve(s) due to other causes of MAP change, the valve stuck monitor bookkeeping 312 can increment a counter each time a stuck valve is detected. For example, each scenario may be associated with its own counter. When the counter(s) exceed a predetermined threshold, the valve stuck decision making 308 can generate a signal that indicates a fault and/or adjusts engine operation. The fault can actuate the MIL 152 and the adjusted engine operation can include commanding the throttle 116 (or its actuation system, e.g., electronic throttle control, or ETC) to a predefined position for limp-home operation in order to prevent engine damage.

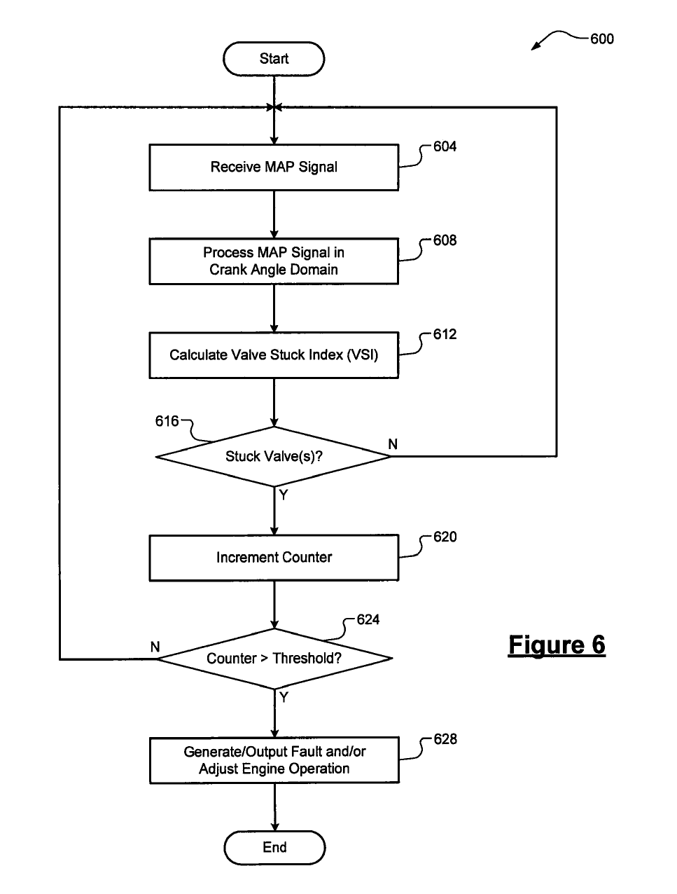

Referring now to FIG. 6, an example flow diagram of a VVL diagnostic method 600 using a MAP signal is illustrated. At 604, the controller 160 can receive the MAP signal from the MAP sensor 120. At 608, the controller 160 can process the MAP signal in the crank angle domain to obtain distinct portions of the MAP signal corresponding to the cylinders 124 of the engine 104. In one implementation, this can include band-pass filtering the MAP signal to remove noise and enhance the SNR of the MAP signal, dividing the MAP signal into its distinct portions corresponding to the cylinders 124, respectively, and low-pass filtering each of the distinct portions of the MAP signal to smooth the distinct portions of the MAP signal.

At 612, the controller 160 can calculate the VSI value based on the distinct portions of the MAP signal. At 616, the controller 160 can detect one or more stuck valves 128 of the engine 104 based on the distinct portions of the MAP signal, the VSI value, and one or more thresholds. In one implementation, the one or more thresholds can include a first threshold for detecting a single stuck valve for a single cylinder 124, a second threshold for detecting a single stuck valve for two or more of the cylinders 124, and a third threshold for detecting two or more stuck valves for each of one or more of the cylinders 124. If no stuck valves are detected, the method 600 can end or return to 604 for one or more additional cycles.

At 620, the controller 160 can increment a counter in response to detecting one or more stuck valves corresponding to the specific cylinder. For example, each scenario discussed above may have its own counter. At 624, the controller 160 can compare the counter to a predetermined threshold. The predetermined threshold can be an appropriate number of stuck valve detections to output a fault and/or adjust engine operation. When the counter exceeds the predetermined threshold, the method 600 can proceed to 628. Otherwise, the method 600 can end or return to 604 for one or more additional cycles. At 628, the controller 160 can generate and output a fault, e.g., activate a MIL, and/or adjust operation of the engine 104, e.g., command limp-home mode. The method 600 can then end.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

What is claimed is:

1. A method, comprising:
receiving, at a controller for an internal combustion engine, the controller having one or more processors, an intake manifold absolute pressure (MAP) signal indicative of an air pressure in an intake manifold of the engine;
processing, at the controller, the MAP signal in a crank angle domain to obtain distinct portions of the MAP signal corresponding to cylinders of the engine, respectively;
calculating, at the controller, a valve stuck index value based on the distinct portions of the MAP signal; and
detecting, at the controller, one or more stuck valves of the engine based on the valve stuck index value and one or more thresholds.

2. The method of claim 1, wherein processing the MAP signal to obtain the distinct portions of the MAP signal is based on a firing order of the cylinders of the engine.

3. The method of claim 2, further comprising filtering, at the controller, each of the distinct portions of the MAP signal using a low-pass filter to smooth the distinct portions of the MAP signal before calculating the valve stuck index value.

4. The method of claim 3, wherein calculating the valve stuck index value includes calculating a norm of the distinct portions of the MAP signal as:
VSI=∥S∥,
after filtering each of the distinct portions of the MAP signal, where VSI represents the valve stuck index value, n represents a number of the cylinders of the engine, and S represents a vector of the distinct portions of the MAP signal s₁-Sₙ.

5. The method of claim 4, wherein the norm of the distinct portions of the MAP signal s₁-sₙ is calculated as:
VSI=\sqrt{s₁²+s₂² . . . +sₙ²}.

6. The method of claim 3, further comprising equalizing, at the controller, the valve stuck index value based on at least one of engine speed and engine load.

7. The method of claim 3, wherein the one or more thresholds include a threshold corresponding to a single stuck valve for a single cylinder.

8. The method of claim 3, wherein the one or more thresholds include a threshold corresponding to two stuck valves for each of one or more cylinders.

9. The method of claim 3, wherein the one or more thresholds include a threshold corresponding to a single stuck valve for two or more cylinders.

10. The method of claim 1, further comprising:
incrementing, at the controller, a counter in response to detecting one or more stuck valves; and
at least one of:
outputting, by the controller, a fault signal when the counter exceeds a predetermined threshold; and
adjusting, by the controller, operation of the engine in response to the counter exceeding the predetermined threshold.

11. An engine system, comprising:
an internal combustion engine configured to combust an air/fuel mixture to generate drive torque; and
a controller configured to:
receive an intake manifold absolute pressure (MAP) signal indicative of an air pressure in an intake manifold of the engine;
process the MAP signal in a crank angle domain to obtain distinct portions of the MAP signal corresponding to cylinders of the engine, respectively;
calculate a valve stuck index value based on the distinct portions of the MAP signal; and
detect one or more stuck valves of the engine based on the valve stuck index value and one or more thresholds.

12. The engine system of claim 11, wherein the controller is configured to process the MAP signal to obtain the distinct portions of the MAP signal based on a firing order of the cylinders of the engine.

13. The engine system of claim 12, wherein the controller is further configured to filter each of the distinct portions of the MAP signal using a low-pass filter to smooth the distinct portions of the MAP signal before calculating the valve stuck index value.

14. The engine system of claim 13, wherein the controller is configured to calculate the valve stuck index value by calculating a norm of the distinct portions of the MAP signal as:
VSI=∥S∥,
after filtering each of the distinct portions of the MAP signal, where VSI represents the valve stuck index value, n represents a number of the cylinders of the engine, and S represents a vector of the distinct portions of the MAP signal s₁-Sₙ.

15. The engine system of claim 14, wherein the norm of the distinct portions of the MAP signal S₁-sₙ is calculated as:
VSI=\sqrt{s₁²+s₂² . . . +sₙ²}.

16. The engine system of claim 13, wherein the controller is further configured to equalize the valve stuck index value based on at least one of engine speed and engine load.

17. The engine system of claim 13, wherein the one or more thresholds include a threshold corresponding to a single stuck valve for a single cylinder.

18. The engine system of claim 13, wherein the one or more thresholds include a threshold corresponding to two stuck valves for each of one or more cylinders.

19. The engine system of claim 13, wherein the one or more thresholds include a threshold corresponding to a single stuck valve for two or more cylinders.

20. The engine system of claim 11, wherein the controller is further configured to:
increment a counter in response to detecting a stuck valve corresponding to the specific cylinder; and
at least one of:
output a fault signal when the counter exceeds a predetermined threshold; and
adjust operation of the engine in response to the counter exceeding the predetermined threshold.
